(19) United States
(12) Patent Application Publication
(10) Pub. No.: US 2018/0292044 A1
(43) Pub. Date: Oct. 11, 2018

(54) PROTECTIVE COVER FOR A STEERING SHAFT RUNNING THROUGH A FOOTWELL, PEDAL UNIT AND MOTOR VEHICLE

(71) Applicants: WEGU GmbH Leichtbausysteme, Kassel (DE); Ford-Werke GmbH, Koeln (DE)

(72) Inventors: Joachim Heidel, Kassel (DE); Kristian Tebbe, Huerth (DE); Dave Wiechmann, Koeln (DE)

(21) Appl. No.: 15/945,335

(22) Filed: Apr. 4, 2018

(30) Foreign Application Priority Data
Apr. 6, 2017 (DE) 10 2017 107 437.6

(51) Int. Cl. F16P 1/02; B62D 1/16; G05G 1/44

(52) U.S. Cl. CPC F16P 1/02; G05G 1/44; B62D 1/16

(57) ABSTRACT

A protective cover for a steering shaft of a motor vehicle running through a footwell of the motor vehicle comprises a protective shell covering the steering shaft towards the footwell and being open at a back side facing away from the footwell, and securing elements for supporting the protective shell at a main body of a pedal unit located in front of the footwell in a rotatably fixed way. In circumferential direction around the steering shaft, the protective cover at its two back ends is configured for abutting against the main body or another motor vehicle part delimiting the footwell towards the front of the motor vehicle.

### CROSS REFERENCE TO RELATED APPLICATIONS

This application claims priority to German patent application No. DE 10 2017 107 437.6 filed on Apr. 6, 2017 and entitled “Schutzabdeckung für eine durch einen Fußraum verlaufende Lenkspindel, Pedalwerkeinheit and Kraftfahrzeug”.

### FIELD OF THE INVENTION

The invention relates to a protective cover for a steering shaft of a motor vehicle, which runs through a footwell of the motor vehicle.

The protective cover of such a steering shaft shields the steering shaft which, when steering the motor vehicle with its steering wheel, rotates with regard to the adjoining footwell to protect the driver of the motor vehicle against contact with the steering shaft and thus against potential injuries and contaminations. This protection is particularly important if the steering shaft has a revolute joint in the area of the footwell. Vice versa, the protective cover also protects such a revolute joint against contamination or damages caused by the driver which could affect its function.

Further, the invention relates to a pedal assembly for a motor vehicle.

### BACKGROUND OF THE INVENTION

German patent application publication DE 10 2004 008 505 A1 discloses a convoluted rubber gaiter as a protective cover for a revolute joint of a steering shaft. The convoluted rubber gaiter has to be pushed onto the steering shaft prior to mounting the steering shaft, and it is fixed to both an input shaft and an output shaft of the steering shaft which are connected via the revolute joint in a rotatably fixed way. The necessary flexibility for unhindered movements of the revolute joint and the input and output shaft which are connected thereto and which can be swiveled with regard to each other is achieved in that the diameter of the convoluted rubber gaiter is sufficiently great and in that it has a sufficient number of convulsions. The convoluted rubber gaiter thus requires installation space both towards the footwell as on that side of the steering shaft facing away from the footwell. Further, the danger of injuries and contaminations due to the steering shaft rotating within the footwell together with the convoluted rubber gaiter is still present. Further, the convoluted rubber gaiter significantly increases the resistance of the steering shaft to rotating so that a reliable function of so-called vehicle dynamic-systems in endangered.

According to Japanese patent application publication JP 2005-199734 A, a protective cover for a revolute joint of a steering shaft running through a footwell is fixed to the floor of the body of the motor vehicle and shields a space for the steering shaft which is located in front of a wall plate of the body from to the footwell. Mounting this protective cover by means of screws to the floor of the body is laborious. The protective cover itself has large dimensions. Thus. it is not cost-effective. Further, itself and the space for the steering shaft shielded by it require a lot of space which is lost for the footwell.

German patent application publication DE 10 2009 055 759 A1 discloses a fixation system for a shielding collar which is arranged around a convoluted rubber gaiter on the motor side to provide a thermal protection for a steering shaft and for a steering shaft sliding ring bearing. The convoluted rubber gaiter encloses the steering shaft in an area of a passage through a wall plate. With its one end, the shielding collar is attached to the wall plate. At its other, motor compartment side end, the shielding collar has a snap-fit ring in which the convoluted rubber gaiter snap-fits in axial direction with a corresponding snap-fit ring of its steering shaft sliding ring bearing and is thus fixed to the shielding collar. The shielding collar consists of an elastic material, particularly silicone, and it requires additional constructive space around the convoluted rubber gaiter. Further, the shielding collar potentially increases the resistance of the steering shaft to rotating even further.

International patent application publication WO 2014/020116 A1 (corresponding to U.S. Pat. No. 9,676,407 B2) discloses a steering shaft for a motor vehicle comprising a protective cover covering the steering shaft towards a footwell, which does not rotate together with the steering shaft. The protective cover covers a revolute joint of the steering shaft with a protective shell which is open at that side facing away from the footwell. Via a fixation device, the protective shell is connected to a steering shaft housing in which an output side part of the steering shaft is rotary-mounted in a releasable but rotatably fixed way. At the end of the protective shell facing away from the fixation device, the protective cover has a connection device which is connected to the input side of the steering shaft in a rotary way. This known protective cover is not voluminous but its mounting is comparatively complex and its protective shell open at the back only provides for a limited protection of the steering shaft and against the steering shaft. Further, the friction between the connection device at the end of the protective shell facing away from the fixation device and the input side of the steering shaft endanger the reliable function of so-called vehicle dynamic systems.

International patent application publication WO 96/22903 A1 (corresponding to U.S. Pat. No. 6,276,483 B1) discloses a security arrangement for motor vehicles comprising a pedal unit which includes at least one bearing block with at least one pedal articulated thereon. The bearing block is held by a carrier component which extends approximately over the width of the vehicle and is at a distance from a wall plate delimiting the passenger compartment. In order to prevent injuries to the feet on front impact, the carrier component is resistant to bending and uncoupled from the scuttle panel. Further, a steering column support for a steering column including a steering shaft is provided at the carrier component.

There still is a need of a protective cover for a steering shaft of a motor vehicle running through a footwell and of a pedal assembly, which provide an enhanced protection against the steering shaft and for the steering shaft at minimum effort.

### SUMMARY OF THE INVENTION

The present invention relates to a protective cover for a steering shaft of a motor vehicle running through a footwell of the motor vehicle, a pedal unit comprising a main body being located in front of the footwell, and the main body or another motor vehicle part delimiting the footwell towards the front of the motor vehicle. The protective cover comprises a protective shell configured for covering the steering shaft towards the footwell and being open at a back side facing away from the footwell, and securing elements configured for supporting the protective shell at the main body of the pedal unit in a rotatably fixed way. At its two back ends, the protective shell is configured for abutting in circumferential direction around the steering shaft against the main body or the other motor vehicle part delimiting the footwell towards the front

The present invention also relates to a pedal assembly for a motor vehicle including a footwell and a steering shaft through the footwell, the footwell being delimited towards the front of the motor vehicle by a motor vehicle part. The pedal assembly comprises a pedal unit including a main body configured to be arranged in front of the footwell of the motor vehicle, a swivel bearing for swivel mounting a pedal with regard to the main body, the pedal being configured to be arranged in the footwell, and a protective cover comprising a protective shell and securing elements configured for supporting the protective shell at the main body of the pedal unit in a rotatably fixed way. A passage for the steering shaft of the motor vehicle extends between the main body and the protective shell of the protective cover, the passage being shielded from the footwell in circumferential direction around the steering shaft in some areas by the protective shell and in other areas by the main body. At its two back ends, the protective shell is configured for abutting in circumferential direction around the steering shaft against the main body or another motor vehicle part being the motor vehicle part delimiting the footwell towards the front of the motor vehicle

Other features and advantages of the present invention will become apparent to one with skill in the art upon examination of the following drawings and the detailed description. It is intended that all such additional features and advantages be included herein within the scope of the present invention, as defined by the claims.

### SHORT DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows a protective cover according to the invention in a perspective view; and

FIG. 2 is a perspective view of a pedal assembly according to the invention comprising a protective cover according to the invention which is attached to a main body of a pedal unit in a rotatably fixed way and shields a steering shaft.

### DETAILED DESCRIPTION

According to the invention, a protective cover for a steering shaft of a motor vehicle running through a footwell comprises a protective shell which covers the steering shaft towards the footwell, which is open at its back side facing away from the footwell and which has securing means for supporting the protective shell at a main body of a pedal unit positioned in front of the footwell in rotatably fixed way. At both of its back ends, the protective shell is provided for abutting in circumferential direction around the steering shaft against the main body or against another motor vehicle part delimiting the footwell towards the front.

The term steering shaft refers to that part of a steering column, which is rotated when rotating the steering wheel of the respective motor vehicle with regard to the body of the motor vehicle. The steering shaft which is covered by the protective cover according to the invention may have a revolute joint in the area of the footwell. Then, the protective cover is particularly important. The protective cover according to the invention, however, is not necessarily provided for covering such a revolute joint.

In any case, the protective cover protects the steering shaft without being directly mounted to or engaging with the steering shaft. Preferably, the protective cover not even touches the steering shaft; thus, the occurrence of friction between the protective cover and the steering shaft is avoided which would endanger the reliable function of so-called vehicle dynamic systems.

The other motor vehicle part delimiting the footwell towards the front may, for example, be an interior lining which needs not to be dimensionally stable as the rotatably fixed support of the protective shell is provided at the main body positioned in front of the footwell.

The protective shell of the protective cover according to the invention is open at its back side facing away from the footwell. Here, however, it directly connects to the pedal unit or the other motor vehicle part delimiting the footwell towards the front. The steering shaft running through between the protective shell and the main body of the pedal unit is thus completely shielded with regard to the footwell.

That the protective shell, in circumferential direction around the steering shaft, is configured at its two back ends for abutting against the main body of the pedal unit or another motor vehicle part delimiting the footwell towards the front means that this abutment of the protective shell of the protective cover according to the invention is provided everywhere where the back ends of the protective shell face the main body or the other motor vehicle part delimiting the footwell towards the front. This includes the possibility that the protective shell, in vertical direction, extends into areas in which it is no longer facing the main body but only the other motor vehicle part delimiting the footwell towards the front.

The main body of the pedal unit at which the protective shell of the protective cover according to the invention is supported via its securing elements in the rotatably fixed way may also be designated as a bearing pedestal or bearing chair for the clutch, gas and/or brake pedal, i.e. for some or all foot pedals of the respective motor vehicle. The main body or the pedal unit is a motor vehicle part of high functionality which is anyway always arranged in front of and sometimes directly adjacent to the footwell of the motor vehicle. Thus, complementary securing arrangements may be provided at low effort for at least some of the securing elements of the protective cover. At very low effort, this is also possible in such a way that the pedal unit may be used both for a left-hand and a right-hand driven motor vehicle with different relative positions of the steering shaft with regard to the pedal unit. In the respective use, some of the entirety of the complementary securing arrangements provided at the pedal unit in total may remain unused. The protective cover according to the invention may also be designed such that it may both be used for a left-hand and for a right-hand driven motor vehicle with a respective other relative position of the steering shaft with regard to the pedal unit. Further, the connection of the back ends of the protective shell to the main body of the pedal unit in circumferential direction around the steering shaft may be made easy by an adapted design of the pedal unit without significantly increasing the expenses to be spent for manufacturing the pedal unit.

Thus, the goal of an enhanced protection of the and against the steering shaft is achieved with the protective cover according to the invention at a minimum effort as desired.

The securing elements of the protective cover according to the invention may be provided for releasably securing the protective shell. In principle, however, the protective cover may also be made such that it may not be removed in an non-destructive way. Thus, it may be ensured that the protective cover is not released unintentionally. If the protective cover according to the invention has been destroyed when removing it, it can be replaced at low cost as, despite its high functionality, it is of a simple construction.

Particularly, some of the securing elements of the protective cover according to the invention may be configured for appending the protective shell to the main body of the pedal unit in a rotatably fixed way. At least one other of the securing elements may then, for example, be configured for snap-fitting it to the main body of the pedal unit or to the other motor vehicle part delimiting the footwell towards the front. Generally, besides a snap-fit of the securing elements in the respective motor vehicle part, any other fixation is also possible. As a rule, however, any other fixation requires a higher mounting effort.

The protective cover may particularly be a shaped body molded of plastic, like, for example by injection molding in a mold. Particularly, the protective cover may be a simple one-part shaped body. The protective cover may also have a further functionality in that it is, for example, made as a crash pad. Such a crash pad may also be shaped of plastic in a mold in that, for example, special deformation areas are injection-molded or foam-molded of another plastic than used for injection-molding the securing elements.

A pedal assembly according to the invention for a motor vehicle comprises pedal unit including a main body to be arranged in front of a footwell of a motor vehicle and at least one swivel bearing for swivel-mounting at least one clutch, gas and/or brake pedal to be arranged within the footwell to the main body, and a protective cover according to the invention supported at the main body in a rotatably fixed way. A passage for the steering shaft of the respective motor vehicle runs between the main body and the protective shell of the protective cover. In circumferential direction around the steering shaft, the steering shaft is shielded with from the footwell in some areas by the protective shell and in the other areas by the main body.

In so far as the main body of the pedal unit is provided for directly delimiting the footwell, a complete shielding of the steering shaft with regard to the footwell is achieved over the longitudinal extension of the protective shell due to the abutment of the protective shell against the main body; otherwise it is achieved due to the abutment of the protective shell against the other motor vehicle part delimiting the footwell towards the front.

In a same way as the protective cover, the main body of the pedal unit may be a shaped body injection molded of a plastic material. Alternatively, the main body may, for example, be molded of a light metal or a light metal alloy.

In this way of manufacturing the main body, it is possible without spending significant additional effort to provide the main body with securing arrangements complementary to at least a part of the securing elements of the protective cover in that the mold used for the manufacture of the shaped body is shaped correspondingly.

In a motor vehicle having a steering shaft running and a footwell and equipped with a pedal assembly according to the invention, the steering shaft runs through the footwell in a passage between the main body of the pedal unit and the protective shell of the protective cover of the pedal assembly. The passage may also extend through another motor vehicle part delimiting the footwell towards the front. The back ends of the protective shell abut against the main body and/or the other motor vehicle part. Thus, the passage is completely shielded from the footwell over the longitudinal extension of the protective shell.

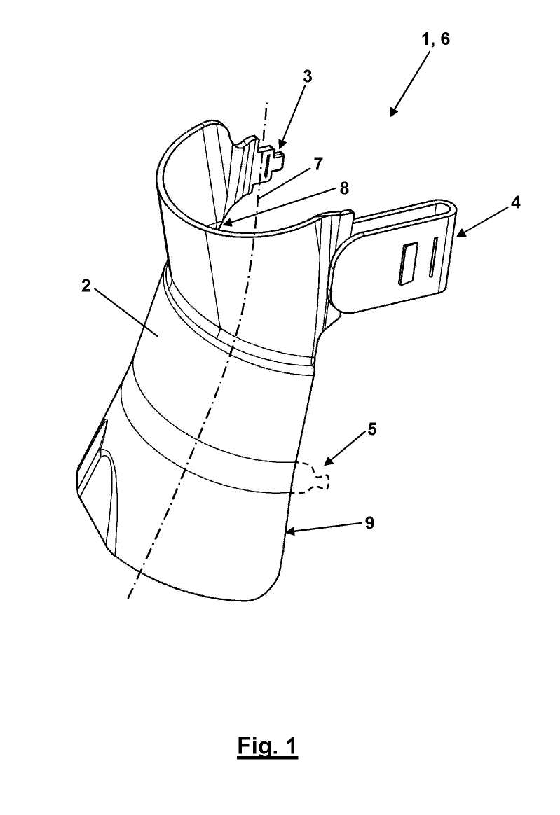

Now referring in greater detail to the drawings, the protective cover 1 depicted in FIG. 1 includes a protective shell 2 and securing elements 3 to 5. Of those securing elements 3 to 5 the securing elements 5 depicted in dashed lines are optional. The entire protective cover 1 is a one-part shaped body 6 injection molded of plastic. The protective shell 2 has the shape of a part of a tube. This means that the protective shell 2 does not extend over full 360° around a tube axis 7 which is bent or curved here but only over about 180° around the tube axis 7. The protective shell 2 serves for covering a steering shaft of a motor vehicle there, where the steering shaft runs through a footwell of the motor vehicle along the tube axis 7. Ends 8 and 9 of the protective shell 2 which are back ends in circumferential direction around the tube axis 7 abut against a motor vehicle part delimiting the footwell; and with the securing elements 3 to 5 the protective shell 2 is fixed to this or another motor vehicle part positioned in front of the footwell in a rotatably fixed way so that the protective shell 2 does not rotate when the steering shaft is rotated with a steering wheel of the respective motor vehicle.

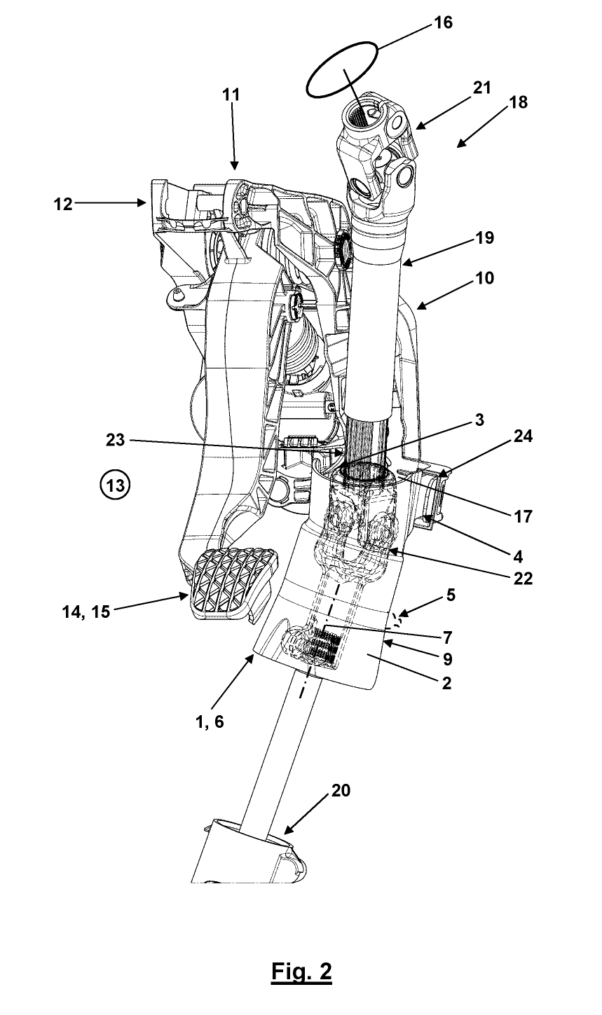

Particularly, the securing elements 3 and 4 of the protective cover 1 are configured for attaching the protective shell 2 to a bearing chair or main body 10 of a pedal unit 11. This attachment results in the pedal assembly 18 depicted in FIG. 2. The pedal unit 11 further comprises a swivel bearing 12 for swivel mounting a pedal 14 within the footwell 13. The pedal 14 is a clutch pedal 15 here. A steering shaft 19 which is depicted in FIG. 2 in addition to the pedal assembly 18 runs along the tube axis 7 through a passage 17 which is in part delimited by the protective shell 2 and in part by the main body 10 and which may further extend through another motor vehicle part which is not depicted here and which may also delimit the footwell 13 towards the front. The steering shaft 19 extends from an only schematically depicted steering wheel 13 up to an only partially depicted steering gearbox 20 and includes two revolute joints 21 and 22. The lower revolute joint 22 arranged at the height of the footwell 13 is covered by the protective shell 2 but without the protective shell 2 touching the steering shaft 19 so that there is no friction between the protective cover 1 and the steering shaft 19. Over the longitudinal extension of the protective shell 2 along the tube axis 7, the steering shaft 19 is thus completely shielded from the footwell 13. The securing elements 5 at both back ends 8 and 9 of the protective shell 2 may be snap-fitted in the other motor vehicle part delimiting the footwell 13 towards the front but not depicted here. In circumferential direction around the steering shaft 19, the back ends 8 and 9 of the protective shell 2 may abut against this other motor vehicle part over their entire longitudinal extension. Then, the securing elements 3 and 4 may be attached to the main body 10 through one or more openings in this further motor vehicle part. Particularly, the securing elements 3 and 4 may be snap-fitted in complementary securing arrangements 23 and 24 which are formed at the main body 10 of the pedal unit 18.

Many variations and modifications may be made to the preferred embodiments of the invention without departing substantially from the spirit and principles of the invention. All such modifications and variations are intended to be included herein within the scope of the present invention, as defined by the following claims.

We claim:

1. A protective cover for a steering shaft of a motor vehicle running through a footwell of the motor vehicle, a pedal unit comprising a main body being located in front of the footwell, the main body or another motor vehicle part delimiting the footwell towards the front of the motor vehicle, the protective cover comprising
a protective shell configured for covering the steering shaft towards the footwell and being open at a back side facing away from the footwell, and
securing elements configured for supporting the protective shell at the main body of the pedal unit in a rotatably fixed way,
wherein the protective shell, at its two back ends, is configured for abutting in circumferential direction around the steering shaft against the main body or the other motor vehicle part delimiting the footwell towards the front.

2. The protective cover of claim 1, wherein the securing elements are configured for releasably securing the protective shell to the main body of the pedal unit.

3. The protective cover of claim 1, wherein some of the securing elements are configured for append the protective shell to the main body in a rotatably fixed way.

4. The protective cover of claim 1, wherein at least one of the securing elements is configured for snap-fitting in the main body.

5. The protective cover of claim 1, wherein at least one of the securing elements is configured for securing the protective shell to the other motor vehicle part delimiting the footwell towards the front.

6. The protective cover of claim 5, wherein the at least one of the securing elements is configured for snap-fitting the protective shell to the other motor vehicle part delimiting the footwell towards the front.

7. The protective cover of claim 1, wherein the protective cover is a shaped body molded of plastic.

8. The protective cover of claim 1, wherein the protective shell includes a crash pad.

9. The protective cover of claim 1, wherein the crash pad is integrated in the protective shell.

10. A pedal assembly for a motor vehicle including a footwell and a steering shaft through the footwell, the footwell being delimited towards the front of the motor vehicle by a motor vehicle part, the pedal assembly comprising
a pedal unit including a main body configured to be arranged in front of the footwell of the motor vehicle,
a swivel bearing for swivel mounting a pedal with regard to the main body, the pedal being configured to be arranged in the footwell, and
a protective cover comprising a protective shell and securing elements configured for supporting the protective shell at the main body of the pedal unit in a rotatably fixed way,
wherein a passage for the steering shaft of the motor vehicle extends between the main body and the protective shell of the protective cover, the passage being shielded from the footwell in circumferential direction around the steering shaft in some areas by the protective shell and in other areas by the main body, and
wherein the protective shell, at its two back ends, is configured for abutting in circumferential direction around the steering shaft against the main body or another motor vehicle part being the motor vehicle part delimiting the footwell towards the front of the motor vehicle.

11. The pedal assembly of claim 10, wherein the main body is a further shaped body molded of a plastic material or a light metal or a light metal alloy.

12. The pedal assembly of claim 10, wherein the main body is provided with securing arrangements which are complementary to at least some of the securing elements of the protective cover.

13. The pedal assembly of claim 10, wherein the passage further runs through a further motor vehicle part delimiting the footwell towards the front.

14. The pedal assembly of claim 10, wherein the passage, over a longitudinal extension of the protective shell, is completely shielded from the footwell.
